(19) United States
(12) Patent Application Publication
(10) Pub. No.: US 2010/0145561 A1
(43) Pub. Date: Jun. 10, 2010

(54) METHOD FOR PREVENTING SECONDARY OVERVOLTAGE-BREAKAGE IN A HYBRID VEHICLE

(75) Inventor: Hongseok Song, Seongnam (KR)

Correspondence Address: EDWARDS ANGELL PALMER & DODGE LLP, P.O. BOX 55874, BOSTON, MA, 02205, US

(73) Assignees: KIA MOTORS CORPORATION, Seoul (KR); HYUNDAI MOTOR COMPANY, Seoul (KR)

(21) Appl. No.: 12/631,000

(22) Filed: Dec. 4, 2009

(30) Foreign Application Priority Data
Dec. 5, 2008 (KR) 10-2008-0123266

(51) Int. Cl. G06F 19/00

(52) U.S. Cl. 701/22; 180/65.275

(57) ABSTRACT

A method for preventing secondary overvoltage-breakage of a hybrid vehicle comprises measuring the temperature of a motor and determining whether the measured temperature exceeds a predetermined temperature at which an over-voltage is induced; performing an energy consumption control logic, when it is determined that the measured temperature exceeds the predetermined temperature, by a mode of increasing charged energy of a 12V battery or by a mode of allowing a 12V electronic component or components to consume energy; and stopping the performance of the energy consumption control logic, when it is determined that the measured temperature does not exceed the predetermined temperature. The method can prevent induction of an over-voltage by regenerated energy in a fail mode in which a main battery is disconnected with high-voltage components.

### CROSS-REFERENCE TO RELATED APPLICATIONS

The present application is based on, and claims priority from, Korean Application Serial Number 10-2008-0123266, filed on Dec. 5, 2008, the disclosure of which is hereby incorporated by reference herein in its entirety.

### TECHNICAL FIELD

The present disclosure relates to a method for preventing secondary overvoltage-breakage of peripheral components of a hybrid vehicle by preventing induction of over-voltage by regenerated energy in a fail mode in which a main battery is disconnected with high-voltage components.

### BACKGROUND ART

In general, hybrid vehicles (or fuel cell vehicles, plug-in hybrid vehicle, electric vehicle) convert electric energy of a high-voltage battery into mechanical energy by driving a motor with an inverter and regenerate energy by absorbing the mechanical energy using the motor.

The magnitude of the regenerated energy is controlled by the inverter. The DC-link of the inverter is connected to a large capacity battery such that the regenerated energy is charged in the large capacity battery, thereby preventing rapid change in voltage of the DC-link.

The voltages of nodes connecting an inverter, a DC converter, and a main switch of a hybrid vehicle are collectively called a system voltage. The system voltage is maintained, when the main switch is turned on, in a predetermined range regardless of the motor speed by a large capacity energy storage device.

However, when the main switch is turned off, the connection with the large capacity storage device is cut, such that the inverter generally cannot control the electric current of the motor and the system voltage increases in proportion to the motor speed.

The increase of the system voltage induces overvoltage to other peripheral devices resulting in overvoltage-breakage of components of the peripheral devices.

One approach that was proposed for preventing such secondary overvoltage-breakage to the components is to use components having sub-components that are overvoltage-resistant at a very high voltage. It, however, requires additional costs.

Another proposed approach is to use a control logic that limits the motor speed by limiting the engine speed with a main switch turned off, or controls the motor and engine speeds in accordance with the motor temperature, regardless of when the main switch is turned off. It, however, does not solve the problem of secondary overvoltage-breakage completely.

The information disclosed in this Background Art section is only for enhancement of understanding of the general background of the invention and should not be taken as an acknowledgement or any form of suggestion that this information forms the prior art already known to a person skilled in the art.

### BRIEF SUMMARY OF THE DISCLOSURE

One aspect of the present invention provides a method of preventing secondary overvoltage-breakage of a hybrid vehicle. The method comprises: measuring the temperature of a motor and determining whether the measured temperature exceeds a predetermined temperature at which an over-voltage is induced; performing an energy consumption control logic, when it is determined that the measured temperature exceeds the predetermined temperature, by a mode of increasing charged energy of a 12V battery or by a mode of allowing a 12V electronic component or components to consume energy; and stopping the performance of the energy consumption control logic, when it is determined that the measured temperature does not exceed the predetermined temperature.

The above and other features of the present invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

For better understanding of the nature and objects of the present invention, reference should be made to the following detailed description with the accompanying drawings, in which:

FIG. 1 is a diagram illustrating the configuration of a hybrid vehicle equipped with a device for preventing secondary overvoltage-breakage according to the present invention; and

FIG. 2 is a diagram illustrating a method of preventing secondary overvoltage-breakage of a hybrid vehicle according to the present invention.

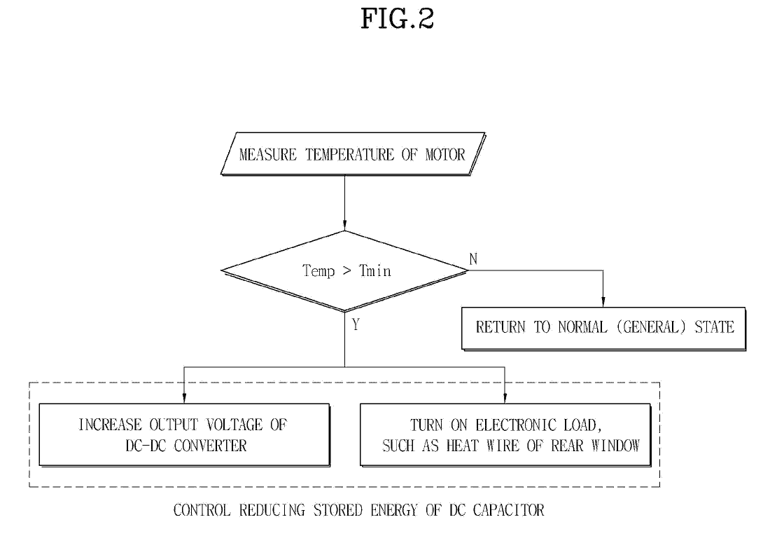

FIG. 3 is a diagram illustrating an operation order of a method for preventing secondary overvoltage-breakage of a hybrid vehicle according to the present invention.

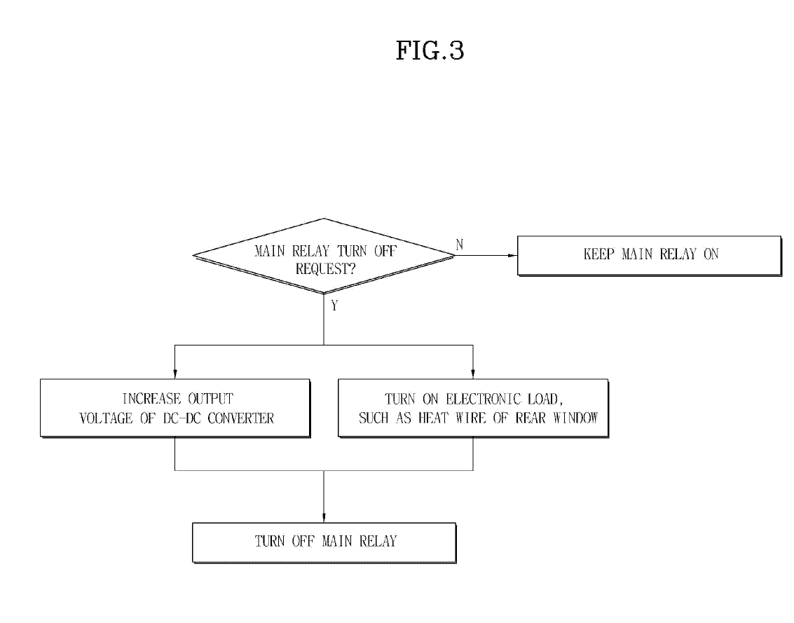

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

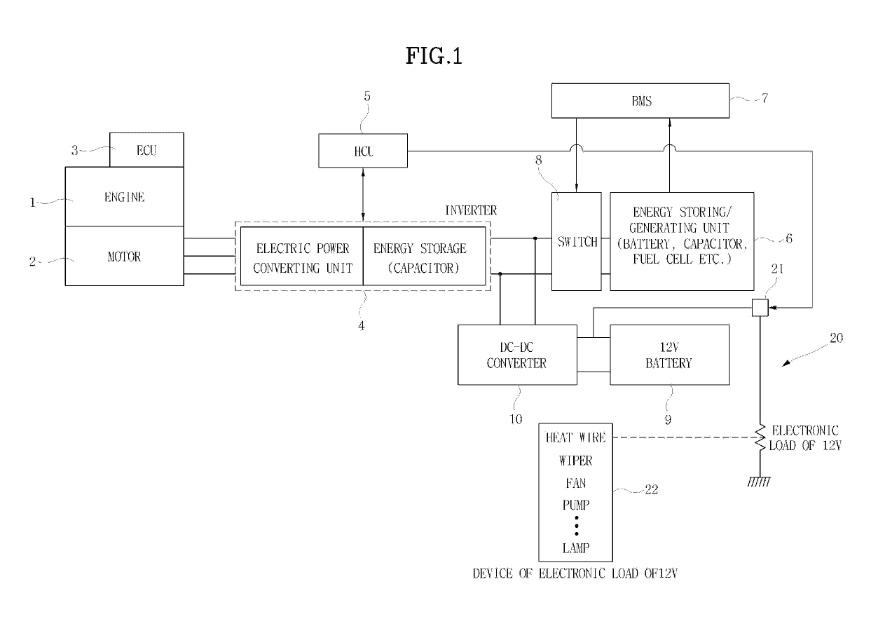

FIG. 1 is a diagram illustrating the configuration of a hybrid vehicle equipped with a device for preventing secondary overvoltage-breakage according to the present invention. The hybrid vehicle includes an engine 1, a motor 2, an inverter 4, and an energy storing/generating unit 6. It further includes an ECU 3 and a hybrid control unit (HCU) 5. The engine 1 and motor 3 are controlled by the ECU 3. The inverter 4 is controlled by the HCU 5 to charge electric energy and control the magnitude of regenerated energy of the motor 2. The energy storing/generating unit 6 stores energy through the inverter 4. The ECU 3 controls the engine 1 and the HCU 5 controls the motor 2 by controlling the inverter 4. The temperature of the motor 2 is measured by the HCU 5. However, the temperature can be measured by other controllers since all the controllers are connected via CAN communication.

The inverter 4 includes a capacitor and an electric power converting unit. The capacitor, as a DC-link, supplies regenerated energy to the energy storing/generating unit 6, which is a large capacity battery, and prevents rapid change in voltage.

The hybrid vehicle further includes a BMS 7 that controls the energy storing/generating unit 6 and a main switch 8 that controls a circuit connecting the inverter 4 with the energy storing/generating unit 6.

A DC-DC converter 10 connected to a 12V battery 9 is connected to a circuit between the main switch 8 and the inverter 4. A system voltage (node voltage) connecting the inverter 4, DC-DC converter 10, and main switch 8 is generated.

Further, the hybrid vehicle is provided with an energy consuming unit 20. The energy consuming unit 20 increases charged energy of the 12V battery 9 or increases energy consumption amount using 12V electronic components, when the ECU 3 controls induction of an over-voltage at a low temperature of the motor 2.

A variety of methods can be used to increase the charged energy of the 12V battery 9 and increase the output voltage of the DC-DC converter 10.

The energy consuming unit 20 can be realized in various configuration and with various components. For example, it may be a 12V electronic component 22 that is led out of the system voltage circuit such that the energy is not stored in the inverter 4, and consumes the energy.

The DC-DC converter (10) may represent an energy transfer or consumption device being able to control the amount of the energy consumption. For an example, the DC-DC converter is replaced by an electric air-condition inverter.

For this, the 12V electronic component 22 uses electric power consuming components, which may be a window heat wire, a wiper motor, a radiator fan, a water pump, a seat heat wire, and a head lamp etc.

The switch 21 can be controlled by the ECU 3. It may be configured to individually control the components of the 12V electronic component 22 or commonly control the components.

It is necessary to measure the temperature of the motor 2 to implement the above-described method for preventing heat breakage of peripheral components. One of the characteristics of the motor 2 is that the lower the temperature of the motor 2, the higher the system voltage may be and vice versa. Accordingly, the secondary overvoltage-breakage can be prevented regardless of whether the main switch 8 is turned on/off.

More particularly, the temperature of the motor 2 is measured and it is determined whether the measured temperature exceeds a predetermined temperature ‘Tmin’ that satisfies a condition to induce an over-voltage.

If it is determined that the measured temperature does not exceed the predetermined temperature ‘Tmin,’ a normal control is performed, in which the electric loads can be controlled by a driver demand (for example, a window heat wire can be controlled to be turned on or off by a driver demand.). On the other hand, if it is determined that the measured temperature exceeds the predetermined temperature ‘Tmin,’ an energy consumption control is performed.

Energy consumption can occur in two modes: (1) by using the DC-DC converter 10 and (2) by using the energy consuming unit 20. The devices and methods according to the present invention can be realized by using at least one of these two modes.

More specifically, in case where energy consumption occurs by using the DC-DC converter 10, energy consumption amount can be increased by increasing the output voltage of the DC-DC converter 10 to thereby increase the charged energy of the 12V battery 9. Here, the output voltage is increased until the temperature of the motor 2 exceeds the predetermined temperature ‘Tmin’.

On the other hand, in case where energy consumption occurs by using the energy consuming unit 20 led from the system voltage circuit, energy consumption amount can be increased by turning on the switch 21 such that energy is consumed through the 12V electronic component 22, such as a window heat wire, a wiper motor, a radiator fan, a water pump, a seat heat wire, and head wire. Energy consumption by the 12V electronic component 22 is performed until the temperature (Temp) of the motor 2 exceeds the predetermined temperature ‘Tmin’. The switch 21 may be configured to individually or commonly operate the 12V electronic component(s) 22 in accordance with the amount of energy that will be consumed.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of preventing secondary overvoltage-breakage of a hybrid vehicle, the method comprising:
measuring the temperature of a motor and determining whether the measured temperature exceeds a predetermined temperature at which an over-voltage may be induced when a switch is turned off;
performing an energy consumption control, when it is determined that the measured temperature exceeds the predetermined temperature, by a mode of increasing charged energy of a 12V battery or by a mode of allowing a 12V electronic component or components to consume energy; and
stopping the performance of the energy consumption control logic, when it is determined that the measured temperature does not exceed the predetermined temperature.

2. The method as defined in claim 1, wherein both the mode of increasing charged energy of the 12V battery and the mode of allowing the 12V electronic component or components to consume energy are implemented.

3. A method of preventing secondary overvoltage-breakage of a hybrid vehicle, the method comprising:
Receiving the main relay turn-off request from a controller in the vehicle, performing an energy consumption control, when it is determined that the measured temperature exceeds the predetermined temperature, by a mode of increasing charged energy of a 12V battery or/and by a mode of allowing a 12V electronic component or components to consume energy,
and then, turning the main relay off.
